(19) United States
(12) Patent Application Publication
(10) Pub. No.: US 2026/0022945 A1
(43) Pub. Date: Jan. 22, 2026

(54) HANDLING LANE CLOSURES

(71) Applicant: Motional AD LLC, Boston, MA (US)

(72) Inventors: Rohit Sridharan, Singapore (SG); Tawit Uthaicharoenpong, Singapore (SG); Tee Yang Tang, Singapore (SG)

(21) Appl. No.: 18/555,356

(22) PCT Filed: Apr. 14, 2023
(86) PCT No.: PCT/US2023/018721

§ 371 Date: Oct. 13, 2023

(51) Int. Cl. G01C 21/34; B60W 60/00

(52) U.S. Cl. CPC G01C 21/3492; B60W 60/001; B60W 2552/00

(57) ABSTRACT

Provided are methods for handling lane closures, which can include obtaining a lane graph including a plurality of nodes and a plurality of edges. A route from a first location to a second location is represented on the lane graph Some methods described also include obtaining at least one node corresponding to a lane segment comprising a lane closure along the route and pruning the lane graph based on the at least one node. Some methods described also include determining an updated route from a current location to the second location using the pruned lane graph and causing the vehicle to navigate along the updated route avoiding the lane closure. Systems and computer program products are also provided.

### BACKGROUND

Lane closures block lanes of a road, preventing vehicles from traveling in a blocked lane. Objects, accidents, construction, road maintenance, and the like can block lanes of a road resulting closures of blocked lanes that are otherwise navigable. Lane closures cause bottlenecks, traffic congestion, and negatively impact use of the road.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram of an implementation of a process for handling lane closures.

FIG. 6 is a diagram of an example lane graph.

FIG. 7 is a diagram of an example roadway.

FIG. 8 is a diagram of an example user interface.

FIG. 9 is a diagram of an example lane closure.

FIGS. 10a-10c are diagrams of example lane graphs with nodes removed to avoid lane closures.

FIG. 11 is a flowchart of a process for handling lane closures

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like. depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components. circuits, and networks have not been described in detail so as not to unnecessarily obscure aspects of the embodiments.

### General Overview

In some aspects and/or embodiments, systems, methods, and computer program products described herein include and/or implement lane closure handling via lane graphs which are used to identify at least part of a route traversed by a vehicle (such as an autonomous vehicle) from an origin to a destination. The lane graph includes (i) nodes (sometimes referred to as vertices) representing lane segments and (ii) edges representing connections between the lane segments (e.g., edges represent lane keep and lane change options). The vehicle traverses the route using the nodes and edges of the lane graph. Sensor data (e.g., camera data, LiDAR data, radar data, and the like) is transmitted from the vehicle to a remote vehicle assist (RVA) system. The RVA system uses the sensor data to identify a lane closure (e.g., a physical obstruction or blockage of a lane, such that the lane cannot be traversed by the vehicle), and identify nodes of the lane graph which correspond to the lane closure (e.g., one or more nodes may be selected by an operator). The identified nodes are added to a lane reject list and sent to the vehicle. Nodes in the lane reject list are removed from the lane graph to generate a pruned lane graph. The vehicle uses the pruned lane graph to determine a route that avoids the lane closure (e.g., the vehicle changes lanes as early as possible to an unobstructed lane).

By virtue of the implementation of systems, methods, and computer program products described herein, techniques for handling lane closures provide advantages including increasing the speed of the determination the routes to avoid the lane closure. Further, the amount of transmitted data is reduced by only transmitting the nodes in the lane reject list to the vehicle. In addition, the process of identifying a lane closure is simplified, resulting in increased efficiency.

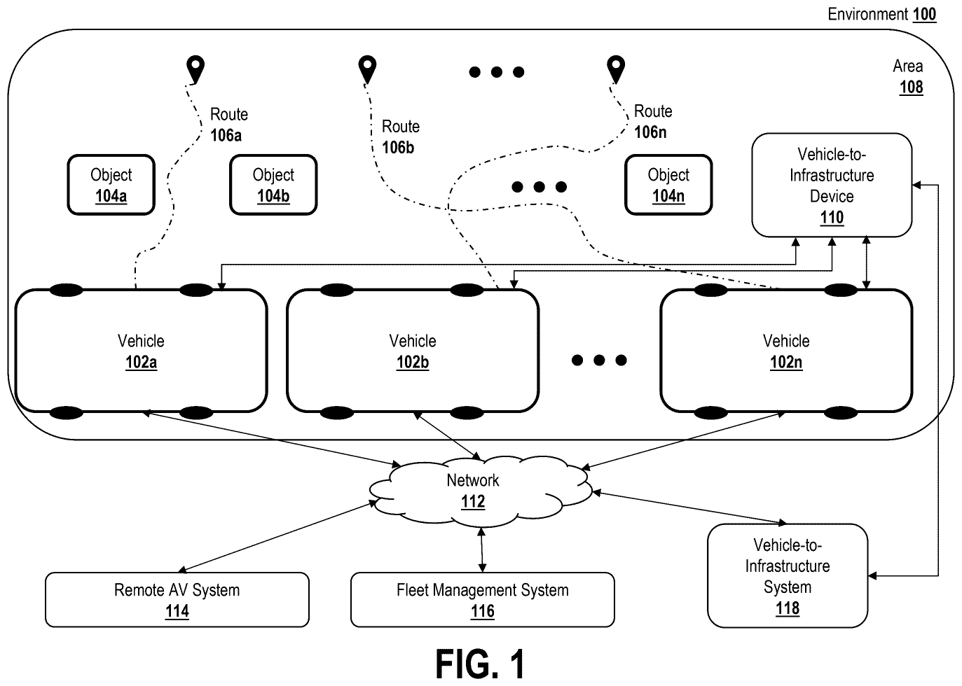

Referring now to FIG. 1, illustrated is example environment 100 in which vehicles that include autonomous systems. as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

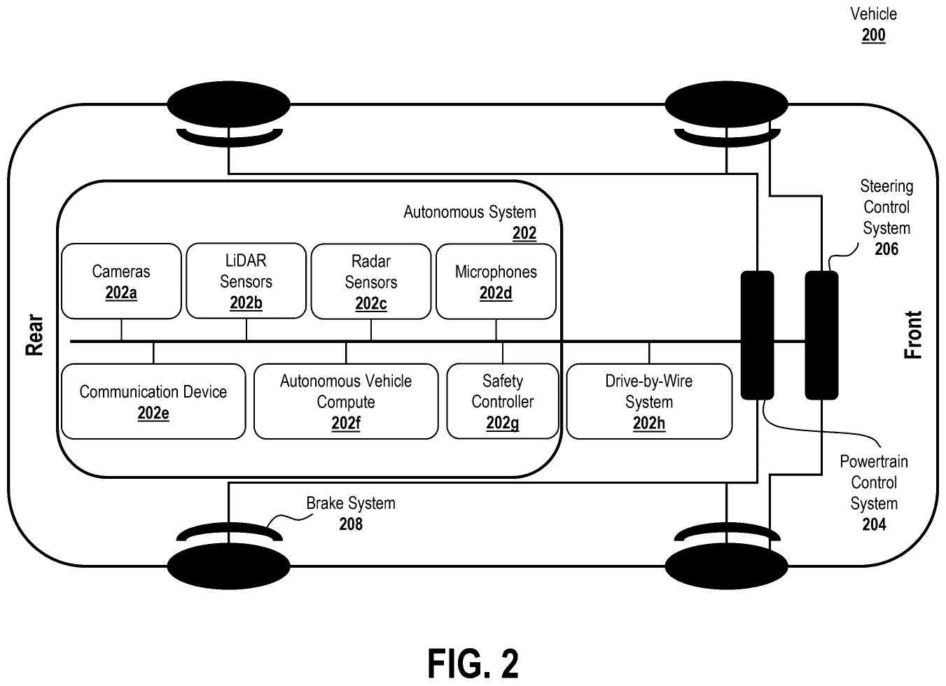

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.). at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114. and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN). a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114. and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicle 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

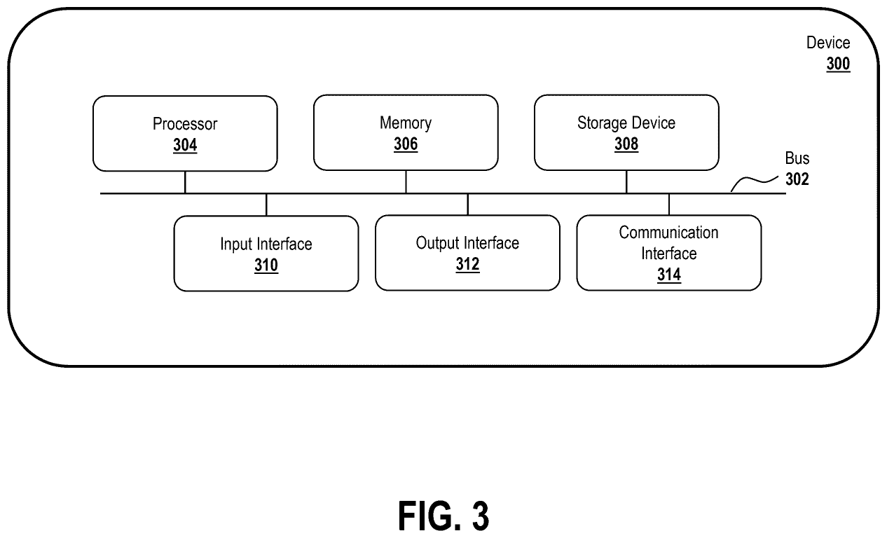

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG. PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f. safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f includes at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units. graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of a V2I device (e.g., a V2I device that is the same as or similar to V2I device 110 of FIG. 1), a V2I system (e.g., a V2I system that is the same as or similar to V2I system 118 of FIG. 1), at least one autonomous vehicle system (e.g., an autonomous vehicle system that is the same as or similar to autonomous vehicle compute 202f of FIG. 2), at least one communication device (e.g., a communication device that is the same or similar to communication device 202e of FIG. 2), and/or one or more devices of network 112 (e.g., one or more devices of a system of network 112). In some embodiments, one or more devices of vehicles 102 (e.g., one or more devices of a system of vehicles 102), one or more devices of a V2I device (e.g., a V2I device that is the same as or similar to V2I device 110 of FIG. 1), one or more devices of a V2I system (e.g., a V2I system that is the same as or similar to V2I system 118 of FIG. 1), one or more autonomous vehicle systems (e.g., an autonomous vehicle system that is the same as or similar to autonomous vehicle compute 202f of FIG. 2), one or more communication devices (e.g., a communication device that is the same or similar to communication device 202e of FIG. 2), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone. a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

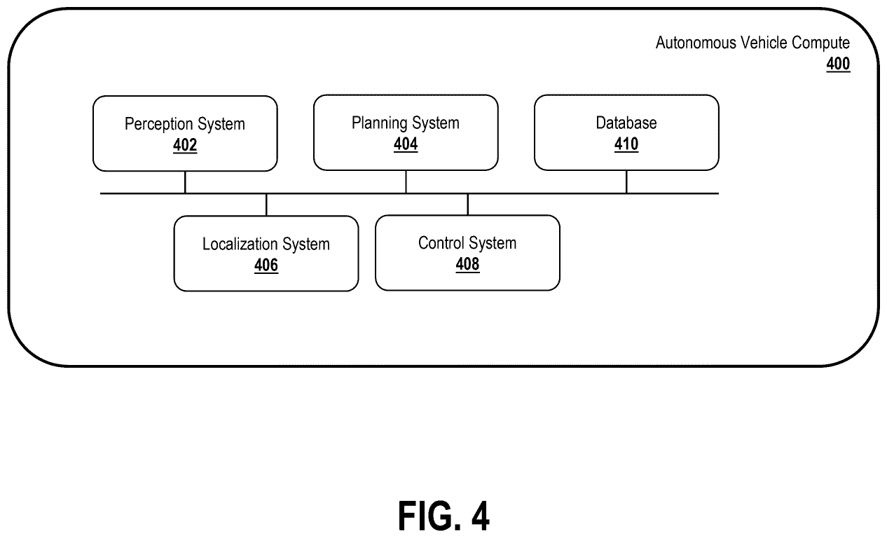

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs. pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deceleration, etc. In some embodiments. planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406. and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404. localization system 406, and/or control system 408 implement at least one machine learning model alone or in combination with one or more of the above-noted systems. In some examples, perception system 402, planning system 404, localization system 406. and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LIDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

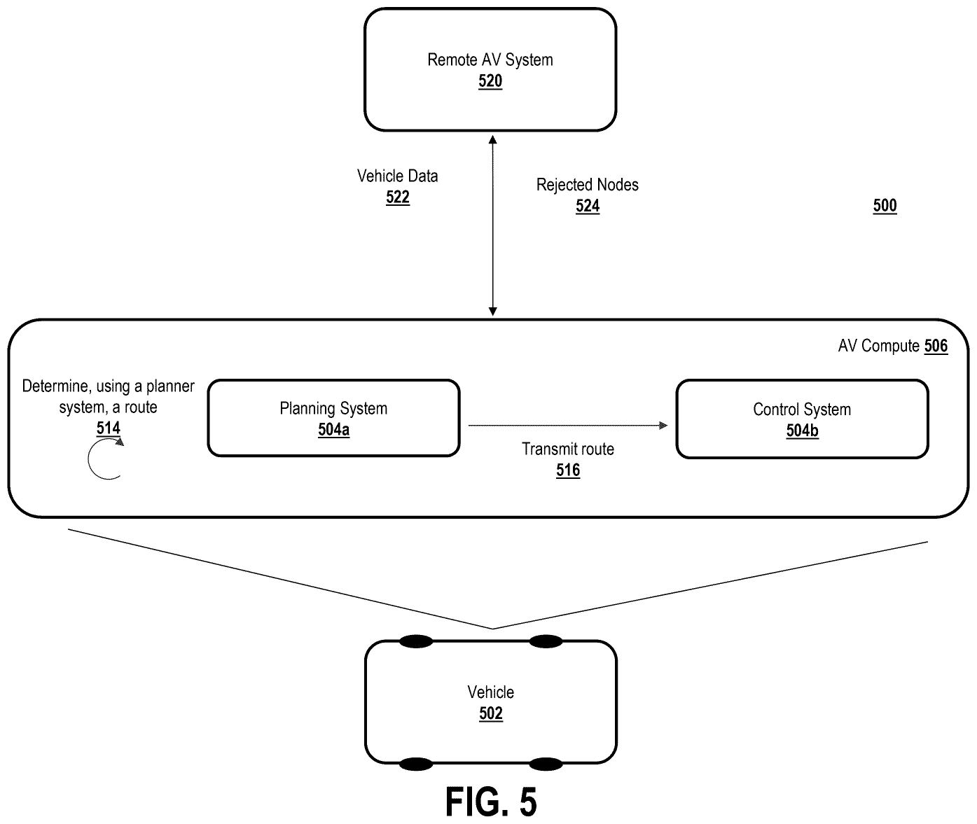

Referring now to FIG. 5, illustrated is a diagram of an implementation 500 of a process for handling lane closures. In some embodiments, implementation 500 includes vehicle 502, AV compute 506, planning system 504a, control system 504a, and remote AV system 520. In some embodiments, vehicle 502 is the same as or similar to vehicles 102 of FIG. 1. In some embodiments, the autonomous vehicle compute 506 is the same as or similar to autonomous vehicle compute 202f of FIG. 2, or autonomous vehicle compute 400 of FIG. 4. In some embodiments, planning system 504a is the same as or similar to planning system 404 of FIG. 4. In some embodiments, control system 504b is the same as or similar to control system 408 of FIG. 4. In some embodiments, remote AV system 520 is the same as or similar to remote AV system 114 of FIG. 1. In some embodiments, remote AV system 520 is a command center.

The AV compute 506 obtains a lane graph which includes nodes and edges. The lane graph is an abstraction of a lane-level road network used for lane-level route planning. In examples, a lane is a division of a road, sometimes marked by lines or signage that separates traffic into a single line of vehicles. A road includes at least one lane of traffic. A lane includes at least one segment, which is a length of the lane over which a single line of vehicles travel. The nodes of the lane graph correspond to a respective lane segment, and the edges correspond to a respective connection between two lane segments. In an example, the edges represent options for the vehicle 502 to keep in a current lane or change to a different lane. In some embodiments, the AV generates the lane graph. In some embodiments, the AV receives the lane graph from the remote AV system 520.

In some embodiments, obtaining the lane graph includes identifying a map of a geographic region within which vehicles 502 can navigate. The map includes information identifying lanes on which vehicles can travel in the geographic region. The map of the geographic region can include geometric properties of the roadway, road network connectivity properties, roadway physical properties (e.g., traffic speed, traffic volume, the number of vehicular and cyclist traffic lanes, lane width, lane traffic directions, or lane marker types and locations, or combinations of them), and spatial locations of road features such as crosswalks, traffic signs or other travel signals of various types.

The planning system 504a determines a route (514) from a first location (e.g., current vehicle location, passenger pickup location) to a second location (e.g., future road segment, destination). In some embodiments, the route from the first location to the second location is represented on the lane graph. The planning system 504a can use the lane graph to select an optimal path to navigate toward a given destination, including lane changes. The planning system 504a can output a list of lane segments and lane connectors to navigate from a current position of the vehicle 502 to the destination. In some embodiments, the route comprises an initial lane and a travel direction of the vehicle.

The vehicle 502 collects data via sensors. In an example, the sensor data can be collected by cameras 202a, LiDAR sensors 202b, radar sensors 202c, and/or microphones 202d of FIG. 2. The vehicle 502 includes a perception system (e.g. that is the same or similar to perception system 402 of FIG. 4). The perception system can classify detected objects (e.g., using the collected sensor data). In some examples, the detected objects are stationary and classified as a road block that prevents travel in the current lane of the vehicle 502.

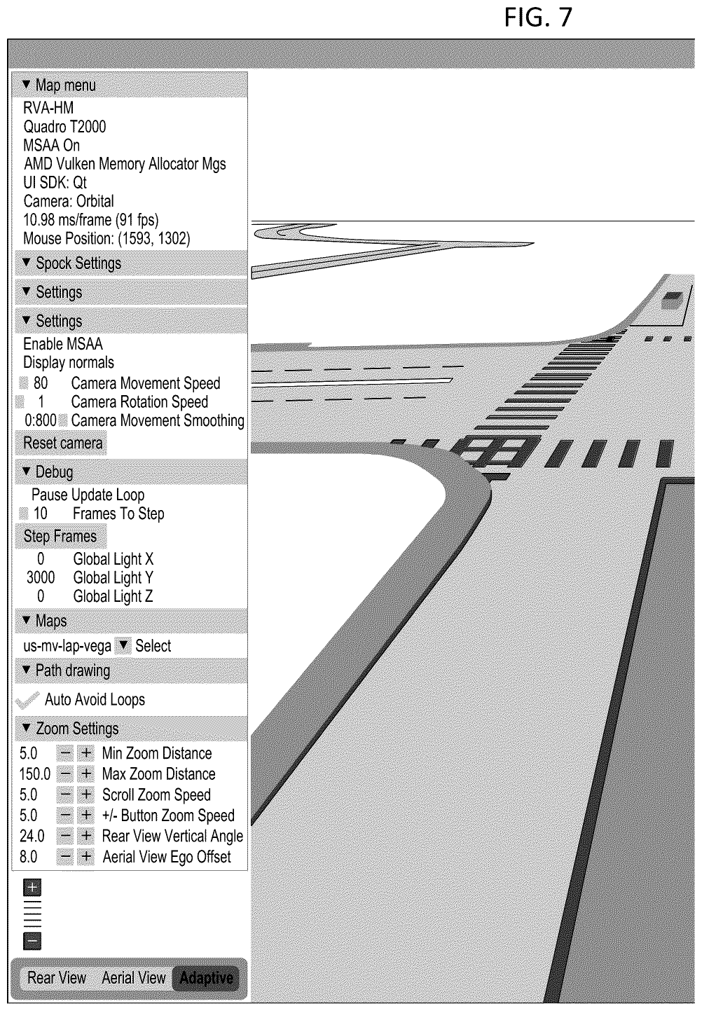

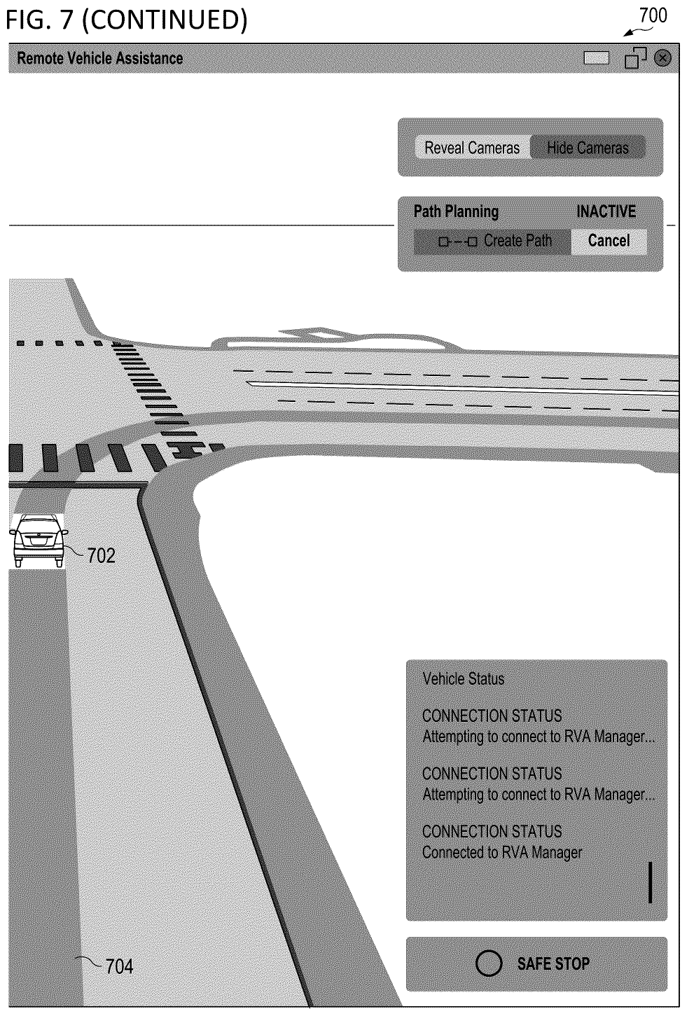

The AV compute 506 transmits vehicle data 522 (e.g., sensor data, detected objects, classifications of detected objects) to the remote AV system 520. The vehicle data 522 is used by the remote AV system 520 to display a user interface (e.g., that is the same or similar to user interface 700 of FIG. 7) to at least one RVA operator. In some embodiments, the user interface includes a 3D view of the vehicle 502 and camera views from the vehicle 502.

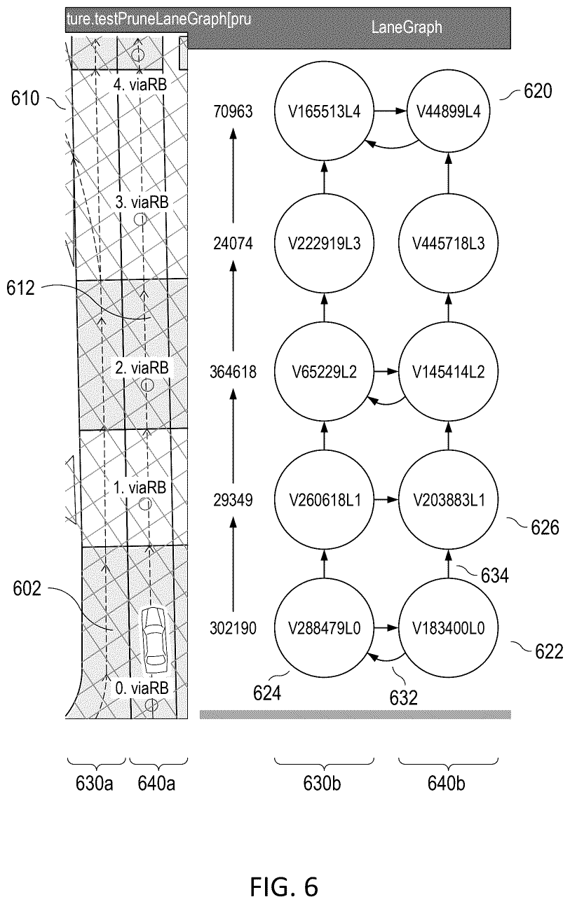

Referring now to FIG. 6, illustrated is a diagram of an example lane graph 620 and corresponding roadway 610. In the example of FIG. 6, a vehicle 602 travels on roadway 610 with lanes 630a and 640a. The lane graph 620 includes columns of nodes 630b and 640b corresponding to lanes 630a and 640a. Every node of the lane graph 620 is assigned a unique identification (ID). As shown in FIG. 6, the vehicle 602 is positioned in a lane segment corresponding to node 622 of the lane graph 620. The vehicle 602 has the option to follow edge 634 to node 626 to remain in lane 640b, or follow edge 632 to node 624 to change lanes to lane 630b. The vehicle 602 determines a trajectory to stay in the right lane of roadway 610 as shown by the trajectory 612. In examples, the trajectory 612 is generated by a planning system of the vehicle 602, such as the planning system 404 of FIG. 4. In some embodiments, the planning system periodically or continuously receives data from a perception system, such as perception system 402 of FIG. 4. The planning system updates the trajectory or generates a different trajectory based on the data generated by perception system. In some embodiments, the trajectory is determined using a lane graph that includes the lane segments available for the vehicle 602 to navigate. The planning system maneuvers the vehicle in traffic according to the lane graph.

Referring now to FIG. 7, illustrated is a diagram of an example user interface 700. In the example of FIG. 7, the user interface 700 may be displayed at a RVA system (e.g., that is the same as or similar to remote AV system 114 of FIG. 1 and/or remote AV system 520 of FIG. 5) to enable an operator to assist a vehicle (e.g., that is the same as or similar to vehicles 102 of FIG. 1 and/or vehicle 502 of FIG. 5). The user interface 700 includes an icon 702 representing the vehicle following a trajectory 704.

The user interface 700 is updated using vehicle data (e.g. that is the same or similar to vehicle data 522 of FIG. 5) received from the vehicle represented by the icon 702. In some embodiments, the vehicle data includes a lane closure (e.g., at least one object classified as a road block). In some embodiments, the vehicle data includes sensor data (e.g., that is the same or similar to sensor data included in vehicle data 522 of FIG. 5). In such embodiments, the RVA system determines the lane closure using the sensor data. In some embodiments, the lane closure can be classified as a type of lane closure (e.g., construction, broken down vehicle).

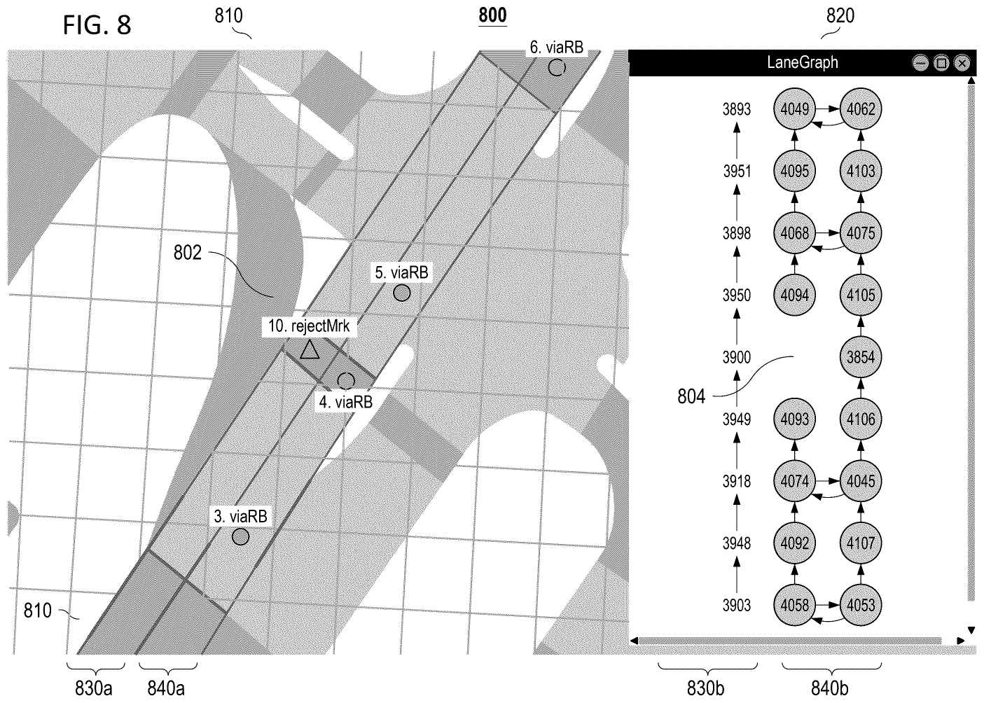

The user interface 700 displays an indication of the lane closure. In some embodiments, the trajectory 704 is updated to indicate obstacles in the path of the vehicle. In an example, the trajectory 704 can turn red to indicate that the trajectory includes a closed lane. In some embodiments, the user interface 700 displays a halo around an obstacle included in the received vehicle data. Lane closures can cause bottlenecks due to vehicle changing lanes to avoid the closed lanes. An effective lane change point (e.g., 30 to 300 meters before the event point) can be determined to avoid accidents or reduce traffic congestion. In some embodiments, the user interface 700 allows (e.g., includes controls) the operator to assist the vehicle 702 to handle a lane closure. In some embodiments, the user interface 700 includes a trajectory tool which allows the operator to draw a single trajectory to avoid a closed lane. In some embodiments, the user interface 700 includes an option to open a lane graph interface element (e.g., that is the same or similar to lane graph 820 of FIG. 8).

FIG. 8 shows a diagram 800 including a map 810 and a lane graph 820. In the example of FIG. 8, there is a lane closure 802 in lane 830a of roadway 810. The lane graph 820 includes columns of nodes 830b and 840b corresponding to lanes 830a and 840a of the roadway 810. In some embodiments, the lane closure 802 is received from at least one vehicle (e.g., the lane closure 802 is included in vehicle data that is the same or similar to vehicle data 522 of FIG. 5). In an example, one or more vehicles detect an object in the roadway 810, classify the object as a road block, and transmit the roadblock to a RVA system (e.g., that is the same as or similar to remote AV system 114 of FIG. 1 and/or remote AV system 520 of FIG. 5). In some embodiments, the RVA receives sensor data (e.g., that is the same or similar to sensor data included in vehicle data 522 of FIG. 5) from at least one vehicle, and determines the lane closure 802 using the received sensor data.

The RVA determines a lane segment corresponding to the lane closure 802 along the route. In an example, an operator of the RVA may select (e.g., click on) a node in the lane graph 820 corresponding to the lane closure. In the example of FIG. 8, the operator has selected the node 804 corresponding to the lane segment including the lane closure 802 along the route.

The lane graph 820 is pruned so that the node 804 corresponding to the lane closure 802 is removed from the lane graph 820. In some embodiments, the lane graph 820 is maintained and pruned at a vehicle (e.g., that is the same as or similar to vehicles 102 of FIG. 1 and/or vehicle 502 of FIG. 5). In such embodiments, the RVA transmits the node 804 to the vehicle, and the vehicle prunes the lane graph 820. In some embodiments, the lane graph is maintained and pruned at the remote AV system. In such embodiments, the lane graph 820 is accessed by the vehicle as needed for calculating a trajectory of the vehicle.

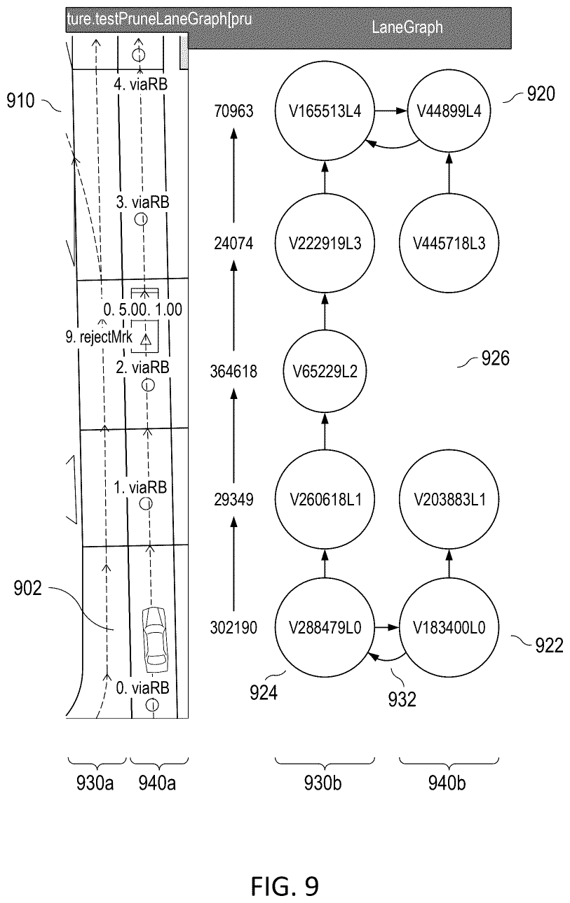

Referring now to FIG. 9, illustrated is a diagram of an example lane graph 920. In the example of FIG. 9, a vehicle 902 (e.g., that is the same as or similar to vehicles 102 of FIG. 1 and/or vehicle 502 of FIG. 5) is on roadway 910 with lanes 930a and 940a. The lane graph 920 includes columns of nodes 930b and 940b corresponding to lanes 930a and 940a. Every node of the lane graph 920 is assigned a unique ID.

A remote AV system (e.g., that is the same as or similar to remote AV system 114 of FIG. 1 and/or remote AV system 520 of FIG. 5) determines a lane segment corresponding to the lane closure along the roadway 910. In an example, an operator of the remote AV system may identify a lane closure and select (e.g., click on) a node corresponding to the lane closure.

The vehicle 902 obtains node 926 corresponding to the lane segment including the lane closure along the route. In some embodiments, the node 926 corresponding to the closure may be selected at the remote vehicle assist and transmitted to the vehicle 902. In some embodiments, the vehicle 902 determines the node 926 (e.g., using sensor data).

The lane graph 920 is pruned so that the node 926 corresponding to the lane closure is removed from the lane graph 920. In some embodiments, the lane graph 920 is maintained and pruned at the vehicle 902. In some embodiments, the lane graph 920 is maintained and pruned at the remote AV system. In such embodiments, the lane graph 920 is accessed by the vehicle 902 as needed for calculating a trajectory of the vehicle.

The vehicle 902 is positioned in a lane segment corresponding to node 922 of the lane graph 920. The vehicle 902 needs to follow edge 932 to node 924 to change lanes to lane 930b in order to avoid the lane closure.

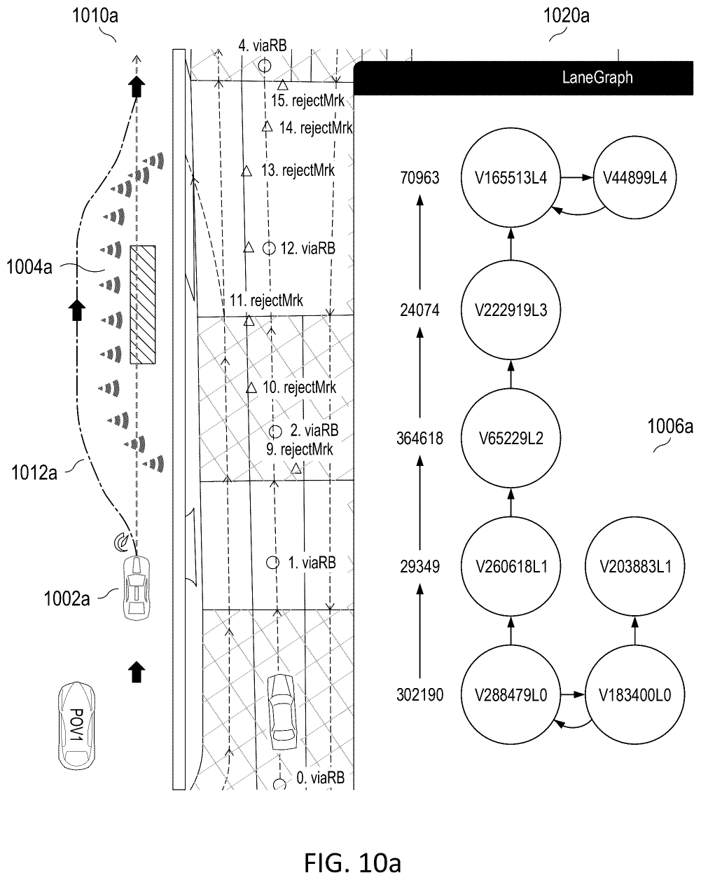

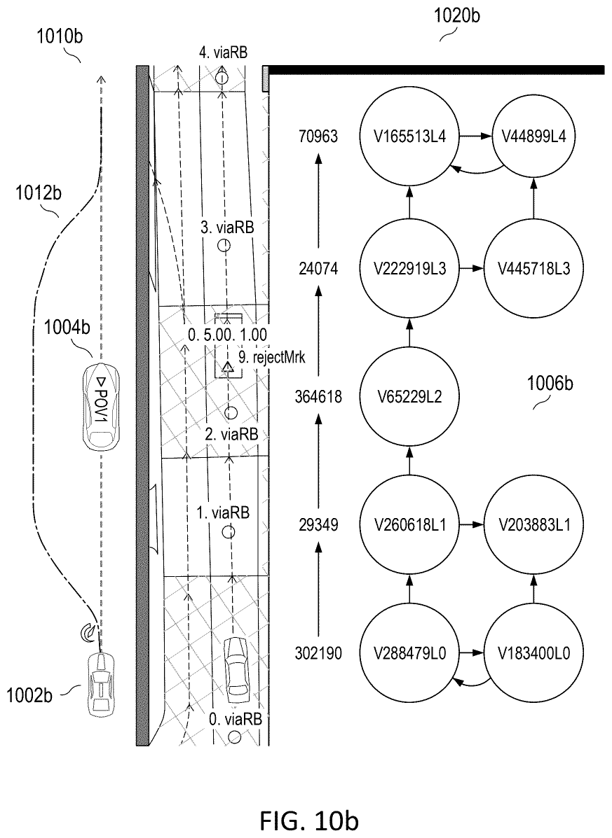

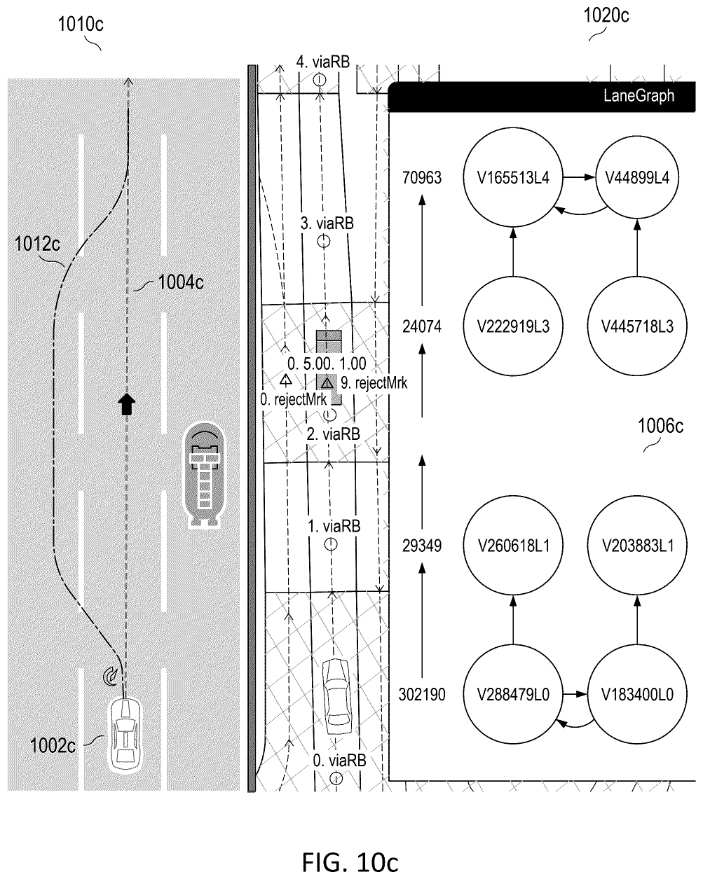

Referring now to FIGS. 10a-10c, illustrated are diagrams of example lane graphs 1020a-1020c with nodes removed to avoid lane closures. In the example of FIG. 10a, a vehicle 1002a is on a roadway 1010a which is obstructed with construction 1004a. Nodes 1006a have been remove from the lane graph 1020a due to the lane closure from the construction 1004a. Two nodes have been removed due to the construction 1004a spanning two lane segments in the same lane. The vehicle 1020a follows the trajectory 1012a in order to avoid the lane closure.

In the example of FIG. 10b, a vehicle 1002b is on a roadway 1010b which is obstructed with a stationary broken vehicle 1004b. A node 1006b has been remove from the lane graph 1020b due to the lane closure from the stationary broken vehicle 1004b. The vehicle 1020b follows the trajectory 1012b in order to avoid the lane closure.

In the example of FIG. 10c, a vehicle 1002c is on a roadway 1010c which is obstructed with a stationary emergency vehicle 1004c. Node 1006c have been remove from the lane graph 1020c due to the lane closure from the stationary emergency vehicle 1004c. Two nodes have been removed due to the construction 1004a spanning two lanes. The vehicle 1020c follows the trajectory 1012c in order to avoid the lane closure. In an example, the trajectory 1012c can traverse a third column of nodes not shown in the lane graph 1020c.

Returning to the example of FIG. 5, the AV compute 506 receives rejected nodes 524 from the remote AV system 520. In some embodiments, the rejected nodes 524 include a lane rejection list of nodes and/or road segments. In such embodiments, the AV compute 506 uses the lane rejection list to prune a lane graph. In some embodiments, the rejected nodes 524 include a lane graph pruned at the remove AV system 520.

The planning system 504a determines an updated route 516 from a current location to a second location using the pruned lane graph. In some embodiments, the current location is different than the first location of the original route (e.g., the vehicle 502 has progress along the original route). The planning system 504a determines the updated route in order to avoid the lane closure. The planning system 504a does not output a route that contains the rejected lane because the nodes corresponding to the rejected lane is removed from the lane graph. In some embodiments, the planning system 504a determines a sequence of edges connecting a sequence of nodes from the first location to the second location.

In some embodiments, the planning system 504a determines a lane change from a first node of the pruned lane graph to a second node of the pruned lane graph along an edge of the pruned lane graph connecting the first node and the second node. In such embodiments, the first node corresponds to a first lane segment in a first lane and the second node corresponds to a second lane segment in a second lane.

The planning system 504a transmits the updated route 516 to control system 504b. The control system 504b causes the vehicle to navigate the updated route avoiding the lane closure.

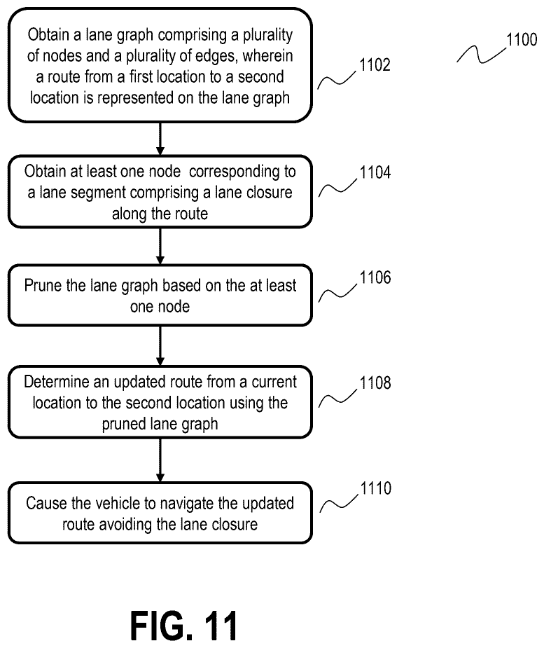

Referring now to FIG. 11, illustrated is a flowchart of a process 1100 for handling lane closures. In some embodiments, one or more of the steps described with respect to process 1100 are performed (e.g., completely, partially, and/or the like) by autonomous system 200. Additionally, or alternatively, in some embodiments one or more steps described with respect to process 1100 are performed (e.g., completely, partially, and/or the like) by another device or group of devices separate from or including autonomous system 200 such as remote AV system 114 of FIG. 1, device 300 of FIG. 3, AV compute 400 of FIG. 4, AV compute 510 of FIG. 5, and remote AV system 520 of FIG. 5.

The autonomous system (e.g., autonomous system 202f of FIG. 2) obtains a lane graph comprising a plurality of nodes and a plurality of edges, wherein a route from a first location to a second location is represented on the lane graph (block 1102). In an example, the plurality of nodes each corresponding to a lane segment, and the plurality of edges each corresponding to a connection between two lane segments. In such an example, the edges can represent lane keep or lane change options. In an example, the route includes an initial lane and a travel direction of the vehicle.

The autonomous system obtains at least one node corresponding to a lane segment comprising a lane closure along the route (block 1104). In an example, the autonomous system identifies a map of a geographic region. In such an example, the map includes information identifying at least one lane on which vehicles can travel in the geographic region.

The autonomous system prunes the lane graph based on the at least one node (block 1106). In an example, the autonomous system removes the at least one node from the lane graph.

The autonomous system determines an updated route from a current location to the second location using the pruned lane graph (block 1108). In an example, the autonomous system determines a sequence of edges from the plurality of edges connecting a sequence of nodes from the plurality of nodes from the first location to the second location. In an example, the updated route includes a lane change from a first node of the pruned lane graph to a second node of the pruned lane graph along an edge of the pruned lane graph connecting the first node and the second node. In such an example, the first node corresponds to a first lane segment in a first lane and the second node corresponds to a second lane segment in a second lane.

The autonomous system causes the vehicle to navigate the updated route avoiding the lane closure (block 1110). In an example, the autonomous system causes the vehicle to change lanes to a lane without an obstruction.

According to some non-limiting embodiments or examples, provided is a method comprising: obtaining, with at least one processor at a vehicle, a lane graph comprising a plurality of nodes and a plurality of edges, wherein a route from a first location to a second location is represented on the lane graph; obtaining, with the at least one processor, at least one node corresponding to a lane segment comprising a lane closure along the route; pruning, with the at least one processor, the lane graph at the vehicle based on the at least one node; determining, with the at least one processor, an updated route from a current location to the second location using the pruned lane graph; and causing, with the at least one processor, the vehicle to navigate along the updated route avoiding the lane closure.

According to some non-limiting embodiments or examples, provided is a system comprising at least one processor, and at least one non-transitory storage media storing instructions that, when executed by the at least one processor, cause the at least one processor to: obtain, at a vehicle, a lane graph comprising a plurality of nodes and a plurality of edges, wherein a route from a first location to a second location is represented on the lane graph; obtain at least one node corresponding to a lane segment comprising a lane closure along the route; prune the lane graph at the vehicle based on the at least one node; determine an updated route from a current location to the second location using the pruned lane graph; and cause the vehicle to navigate along the updated route avoiding the lane closure.

According to some non-limiting embodiments or examples, provided is at least one non-transitory storage media storing instructions that, when executed by at least one processor, cause the at least one processor to: obtain, at a vehicle. a lane graph comprising a plurality of nodes and a plurality of edges, wherein a route from a first location to a second location is represented on the lane graph; obtain at least one node corresponding to a lane segment comprising a lane closure along the route; prune the lane graph at the vehicle based on the at least one node; determine an updated route from a current location to the second location using the pruned lane graph; and cause the vehicle to navigate along the updated route avoiding the lane closure.

Further non-limiting aspects or embodiments are set forth in the following numbered clauses:

Clause 1: A method comprising: obtaining, with at least one processor at a vehicle, a lane graph comprising a plurality of nodes and a plurality of edges, wherein a route from a first location to a second location is represented on the lane graph; obtaining, with the at least one processor, at least one node corresponding to a lane segment comprising a lane closure along the route; pruning, with the at least one processor, the lane graph at the vehicle based on the at least one node; determining, with the at least one processor, an updated route from a current location to the second location using the pruned lane graph; and causing, with the at least one processor, the vehicle to navigate along the updated route avoiding the lane closure.

Clause 2: The method of clause 1, wherein the plurality of nodes each correspond to a lane segment, and the plurality of edges each correspond to a connection between two lane segments.

Clause 3: The method of clause 2, wherein determining the updated route comprises: determining a sequence of edges from the plurality of edges connecting a sequence of nodes from the plurality of nodes from the first location to the second location; and determining the updated route based on the sequence of edges.

Clause 4: The method of any of clause 1-3, wherein the updated route comprises a lane change from a first node of the pruned lane graph to a second node of the pruned lane graph along an edge of the pruned lane graph connecting the first node and the second node, and wherein the first node corresponds to a first lane segment in a first lane and the second node corresponds to a second lane segment in a second lane.

Clause 5: The method of any of clause 1-4, wherein pruning the lane graph comprises removing the at least one node from the lane graph.

Clause 6: The method any of clause 1-5, further comprising transmitting sensor data to a remote system to cause the remote system to determine a lane segment corresponding to the lane closure along the route.

Clause 7: The method of any of clause 1-6, wherein obtaining the lane graph comprises identifying a map of a geographic region, the map comprising information identifying at least one lane on which vehicles can travel in the geographic region.

Clause 8: The method of any of clause 1-7, wherein the route comprises an initial lane and a travel direction of the vehicle.

Clause 9: A system, comprising: at least one processor, and at least one non-transitory storage media storing instructions that, when executed by the at least one processor, cause the at least one processor to: obtain, at a vehicle. a lane graph comprising a plurality of nodes and a plurality of edges, wherein a route from a first location to a second location is represented on the lane graph; obtain at least one node corresponding to a lane segment comprising a lane closure along the route; prune the lane graph at the vehicle based on the at least one node; determine an updated route from a current location to the second location using the pruned lane graph; and cause the vehicle to navigate along the updated route avoiding the lane closure.

Clause 10: The system of clause 9, wherein the plurality of nodes each correspond to a lane segment, and the plurality of edges each correspond to a connection between two lane segments.

Clause 11: The system of clause 10, the instructions that cause the at least one processor to determine the updated route cause the at least one processor to: determine a sequence of edges from the plurality of edges connecting a sequence of nodes from the plurality of nodes from the first location to the second location; and determine the updated route based on the sequence of edges.

Clause 12: The system of clause 9-11, the updated route comprises a lane change from a first node of the pruned lane graph to a second node of the pruned lane graph along an edge of the pruned lane graph connecting the first node and the second node, and wherein the first node corresponds to a first lane segment in a first lane and the second node corresponds to a second lane segment in a second lane.

Clause 13: The system of clause 9-12, wherein the instructions that cause the at least one processor to prune the lane graph cause the at least one processor to remove the at least one node from the lane graph.

Clause 14: The system of clause 9-13, wherein the instructions further cause the at least one processor to transmit sensor data to a remote system to cause the remote system to determine a lane segment corresponding to the lane closure along the route.

Clause 15: The method of any of clause 9-14, the instructions that cause the at least one processor to obtain the lane graph cause the at least one processor to identify a map of a geographic region, the map comprising information identifying at least one lane on which vehicles can travel in the geographic region.

Clause 16: The method of any of clause 9-15, wherein the route comprises an initial lane and a travel direction of the vehicle.

Clause 17: At least one non-transitory storage media storing instructions that, when executed by at least one processor, cause the at least one processor to: obtain, at a vehicle, a lane graph comprising a plurality of nodes and a plurality of edges, wherein a route from a first location to a second location is represented on the lane graph; obtain at least one node corresponding to a lane segment comprising a lane closure along the route; prune the lane graph at the vehicle based on the at least one node; determine an updated route from a current location to the second location using the pruned lane graph; and cause the vehicle to navigate along the updated route avoiding the lane closure.

Clause 18: The at least one non-transitory storage media of clause 17, wherein the plurality of nodes each correspond to a lane segment, and the plurality of edges each correspond to a connection between two lane segments.

Clause 19: The at least one non-transitory storage media of clause 18, the instructions that cause the at least one processor to determine the updated route cause the at least one processor to: determine a sequence of edges from the plurality of edges connecting a sequence of nodes from the plurality of nodes from the first location to the second location; and determining the updated route based on the sequence of edges.

Clause 20: The at least one non-transitory storage media of clause 17-19, the updated route comprises a lane change from a first node of the pruned lane graph to a second node of the pruned lane graph along an edge of the pruned lane graph connecting the first node and the second node, and wherein the first node corresponds to a first lane segment in a first lane and the second node corresponds to a second lane segment in a second lane.

Clause 21: The at least one non-transitory storage media of clause 17-20, wherein pruning the lane graph comprises removing the at least one node from the lane graph.

Clause 22: The at least one non-transitory storage media of clause 17-21, further comprising transmitting sensor data to a remote system to cause the remote system to determine a lane segment corresponding to the lane closure along the route.

Clause 23: The at least one non-transitory storage media of clause 17-22, wherein obtaining the lane graph comprises identifying a map of a geographic region, the map comprising information identifying at least one lane on which vehicles can travel in the geographic region.

Clause 24: The at least one non-transitory storage media of clause 17-23, wherein the route comprises an initial lane and a travel direction of the vehicle.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
obtaining, with at least one processor at a vehicle, a lane graph comprising a plurality of nodes and a plurality of edges, wherein a route from a first location to a second location is represented on the lane graph;
obtaining, with the at least one processor, at least one node corresponding to a lane segment comprising a lane closure along the route;
pruning, with the at least one processor, the lane graph at the vehicle based on the at least one node;
determining, with the at least one processor, an updated route from a current location to the second location using the pruned lane graph; and
causing, with the at least one processor, the vehicle to navigate along the updated route avoiding the lane closure.

2. The method of claim 1, wherein the plurality of nodes each correspond to a lane segment, and the plurality of edges each correspond to a connection between two lane segments.

3. The method of claim 2, wherein determining the updated route comprises:
determining a sequence of edges from the plurality of edges connecting a sequence of nodes from the plurality of nodes from the first location to the second location; and
determining the updated route based on the sequence of edges.

4. The method of claim 1, wherein the updated route comprises a lane change from a first node of the pruned lane graph to a second node of the pruned lane graph along an edge of the pruned lane graph connecting the first node and the second node, and
wherein the first node corresponds to a first lane segment in a first lane and the second node corresponds to a second lane segment in a second lane.

5. The method of claim 1, wherein pruning the lane graph comprises removing the at least one node from the lane graph.

6. The method of claim 1, further comprising transmitting sensor data to a remote system to cause the remote system to determine a lane segment corresponding to the lane closure along the route.

7. The method of claim 1, wherein obtaining the lane graph comprises identifying a map of a geographic region, the map comprising information identifying at least one lane on which vehicles can travel in the geographic region.

8. The method of claim 1, wherein the route comprises an initial lane and a travel direction of the vehicle.

9. A system, comprising:
at least one processor, and
at least one non-transitory storage media storing instructions that, when executed by the at least one processor, cause the at least one processor to:
obtain, at a vehicle, a lane graph comprising a plurality of nodes and a plurality of edges, wherein a route from a first location to a second location is represented on the lane graph;
obtain at least one node corresponding to a lane segment comprising a lane closure along the route;
prune the lane graph at the vehicle based on the at least one node;
determine an updated route from a current location to the second location using the pruned lane graph; and
cause the vehicle to navigate along the updated route avoiding the lane closure.

10. The system of claim 9, wherein the plurality of nodes each correspond to a lane segment, and the plurality of edges each correspond to a connection between two lane segments.

11. The system of claim 10, the instructions that cause the at least one processor to determine the updated route cause the at least one processor to:
determine a sequence of edges from the plurality of edges connecting a sequence of nodes from the plurality of nodes from the first location to the second location; and
determine the updated route based on the sequence of edges.

12. The system of claim 9, the updated route comprises a lane change from a first node of the pruned lane graph to a second node of the pruned lane graph along an edge of the pruned lane graph connecting the first node and the second node, and
wherein the first node corresponds to a first lane segment in a first lane and the second node corresponds to a second lane segment in a second lane.

13. The system of claim 9, wherein the instructions that cause the at least one processor to prune the lane graph cause the at least one processor to remove the at least one node from the lane graph.

14. The system of claim 9, wherein the instructions further cause the at least one processor to transmit sensor data to a remote system to cause the remote system to determine a lane segment corresponding to the lane closure along the route.

15. The method of claim 9, the instructions that cause the at least one processor to obtain the lane graph cause the at least one processor to identify a map of a geographic region, the map comprising information identifying at least one lane on which vehicles can travel in the geographic region.

16. The method of claim 9, wherein the route comprises an initial lane and a travel direction of the vehicle.

17. At least one non-transitory storage media storing instructions that, when executed by at least one processor, cause the at least one processor to:
obtain, at a vehicle, a lane graph comprising a plurality of nodes and a plurality of edges, wherein a route from a first location to a second location is represented on the lane graph;
obtain at least one node corresponding to a lane segment comprising a lane closure along the route;
prune the lane graph at the vehicle based on the at least one node;
determine an updated route from a current location to the second location using the pruned lane graph; and
cause the vehicle to navigate along the updated route avoiding the lane closure.

18. The at least one non-transitory storage media of claim 17, wherein the plurality of nodes each correspond to a lane segment, and the plurality of edges each correspond to a connection between two lane segments.

19. The at least one non-transitory storage media of claim 18, the instructions that cause the at least one processor to determine the updated route cause the at least one processor to:
determine a sequence of edges from the plurality of edges connecting a sequence of nodes from the plurality of nodes from the first location to the second location; and
determining the updated route based on the sequence of edges.

20. The at least one non-transitory storage media of claim 17, the updated route comprises a lane change from a first node of the pruned lane graph to a second node of the pruned lane graph along an edge of the pruned lane graph connecting the first node and the second node, and
wherein the first node corresponds to a first lane segment in a first lane and the second node corresponds to a second lane segment in a second lane.
